(19) United States
(12) Patent Application Publication
(10) Pub. No.: US 2026/0080055 A1
(43) Pub. Date: Mar. 19, 2026

(54) COMMON VULNERABILITIES AND EXPOSURE SCALING

(71) Applicant: Lucidum Inc., Cincinnati, OH (US)

(72) Inventors: Joel M. Fulton, Cincinnati, OH (US); Jeremy Sherwood, Beaverton, OR (US); Shuning Wu, Mountain View, CA (US); Kai Yan, Austin, TX (US)

(21) Appl. No.: 18/889,638

(22) Filed: Sep. 19, 2024

(51) Int. Cl. G06F 21/55; G06F 21/57

(52) U.S. Cl. CPC G06F 21/552; G06F 21/577; G06F 2221/034

(57) ABSTRACT

Methods, systems, and devices for collecting risk information associated with common vulnerabilities and exposures (CVEs) from multiple CVE data sources and generating a combined CVE risk score are described. A data security system may monitor for and manage data security risks associated with one or more computing or assets. The data security system may collect CVE risk information from multiple CVE data sources. The data security system may detect the presence of a computing objects associated with a CVE on a monitored computing asset. The data security system may generate a combined risk score for the presence of the computing objects associated with the CVE on the computing asset based on the risk information collected from the multiple CVE data sources and based on contextual information associated with the computing asset.

### FIELD OF TECHNOLOGY

The present disclosure relates generally to database systems and data processing, and more specifically to common vulnerabilities and exposures scaling.

### BACKGROUND

A data security system may be employed to detect and manage data security risks associated with one or more computing assets. The data monitored by the data security system may be generated, stored, or otherwise used by the one or more computing assets, examples of which may include mobile phones, tablet computers, personal computers, servers, databases, virtual machines, cloud computing systems, file systems (e.g., network-attached storage (NAS) systems), or other data storage or processing systems. For example, a data security system may monitor for malware and/or suspicious activity within the one or more computing assets. In some examples, a data security system may receive indications of known types of malware from one or more malware information sources. The data security system may monitor the one or more computing assets for the known types of malware.

### BRIEF DESCRIPTION OF THE DRAWINGS

FIG. 1 illustrates an example of a computing environment that supports common vulnerabilities and exposures (CVE) scaling in accordance with aspects of the present disclosure.

FIG. 2 shows an example of a combined CVE risk score generation diagram that supports CVE scaling in accordance with aspects of the present disclosure.

FIG. 3 shows an example of a user interface (UI) view that supports CVE scaling in accordance with aspects of the present disclosure.

FIG. 4 shows an example of a UI view that supports CVE scaling in accordance with aspects of the present disclosure.

FIG. 5 shows an example of a UI view that supports CVE scaling in accordance with aspects of the present disclosure.

FIG. 6 shows an example of a process flow that supports CVE scaling in accordance with aspects of the present disclosure.

FIG. 7 shows a block diagram of a data security system that supports CVE scaling in accordance with aspects of the present disclosure.

FIG. 8 shows a diagram of a system including a device that supports CVE scaling in accordance with aspects of the present disclosure.

FIGS. 9 through 13 show flowcharts illustrating methods that support CVE scaling in accordance with aspects of the present disclosure.

### DETAILED DESCRIPTION

A data security system may be employed to monitor for and manage data security risks associated with one or more computing or assets. For example, the one or more computing assets may be associated with an entity which may be a customer or subscriber of the data security system. For example, an entity may be an individual or an organization. A computing asset may be any device, physical or virtual, capable of processing, storing, transmitting, and/or receiving data. For example, a computing asset may be a stationary device (e.g., a desktop computer or access point) or a mobile device (e.g., a laptop computer, a tablet computer, or a smart phone). As another example, a computing asset may be a commercial computing device, such as a server or collection of servers. In some examples, a computing asset may be a virtual device (e.g., a virtual machine). In some examples, the data security system may scan (e.g., periodically or on-demand) or may otherwise monitor for security risks based on computing objects (e.g., files, software applications, or any other programming elements) stored at or accessible to the computing assets. For example, the data security system may store a listing of known malware, and the data security system may monitor for the known malware within the computing assets monitored by the data security system. As another example, a data security system may monitor for suspicious activity on or associated with one or more computing assets. For example, the data security system may track which user accounts access and/or otherwise use computing assets, and the data security system may track unauthorized access to computing assets or computing resources.

In some examples, the data security system may track common vulnerabilities and exposures (CVEs). A vulnerability may be defined as a weakness in computational logic (e.g., code) found in software and hardware components (e.g., in computing objects) that, when exploited, may results in a negative impact to confidentiality, integrity, or availability of data. A CVE may be a publicly known information security vulnerability associated with a particular computing object. Each CVE may be associated with a particular CVE identifier.

For example, the National Vulnerability Database (NVD) from the National Institute of Standards and Technology (NIST) may provide list of publicly known CVEs that are each assigned a CVE identifier. Multiple CVE information sources may provide risk information regarding particular CVEs, where the CVEs may be uniformly identified by the multiple CVE information sources using the assigned respective CVE identifiers.

For example, the NVD may provide a Common Vulnerability Scoring System (CVSS) score and severity level associated with a particular CVE identifier. CVSS may assign severity scores to vulnerabilities, allowing responders (e.g., administrators or users of a data security system) to prioritize responses and resources according to the severity of the threat.

CVSS scores may be calculated based on a formula that depends on several metrics that approximate ease and impact of an exploit of the vulnerability and may range from 0 to 10, with 10 being the most severe.

As another example, the Cybersecurity and Infrastructure Security Agency (CISA) may provide a known exploited vulnerabilities (KEV) catalog that may indicate, by CVE identifier, which CVEs have actually been exploited in the real-world. For example, entities which have been victims of an exploitation of a CVE may report the exploitation to the CISA, and the CISA may update the KEV catalog based on such reports.

As another example, the Forum of Incident Response and Security Teams (FIRST) may provide an Exploit Prediction Scoring System (EPSS) score that may indicate for a particular CVE (by CVE identifier), an estimated likelihood (e.g., probability) that the particular CVE will be exploited. The EPSS score may provide a probability score between 0 and 1 (e.g., between 0% and 100% likelihood) of real-world exploitation of a CVE, where the higher the score, the greater the probability that a vulnerability will be exploited.

As another example, data sources such as CVE.org may provide a catalog of known fixes or corrective actions for CVEs by CVE identifier. For example, when a data security professional identifies a corrective action for a particular CVE, the data security professional may update the catalog of known fixes or corrective actions for the particular CVE.

A data security system may monitor for the presence of CVEs within the computing assets monitored by the data security system. For example, the data security system may identify the presence of a computing object associated with the vulnerability identified by the CVE identifier. For example, the NVD may indicate the particular computing object associated with each CVE identifier. As described herein, the data security system may collect CVE risk information from multiple CVE information sources. The data security system may generate a combined CVE risk score for a particular CVE (e.g., a CVE associated with a particular VE identifier) based on the risk information collected from the multiple CVE information sources. For example, the data security system may generate the combined CVE risk score for a particular NVE via adjusting the CVSS score received from the NVD based on whether the corresponding CVE identifier is included in the KEV catalog, whether the corresponding CVE has an identified corrective action in a catalog of known fixes, and/or based on the corresponding EPSS score.

Accordingly, CVSS and/or EPSS scores may be positively correlated with the generated combined CVE risk score. For example, the more severe a risk is for a CVE (e.g., as indicated by a higher CVSS score), or the higher the probability the vulnerability will actually be exploited (e.g., as indicated by the EPSS score), the higher the generated combined CVE risk score may be for the CVE. As another example, the generated combined CVE risk score may be increased if the CVE identifier appears in the KEV catalog (e.g., if a vulnerability associated with a CVE has actually been exploited, the generated combined CVE risk score for that CVE may be increased). As another example, if the data security system identifies a corrective action indicated for the particular CVE (e.g., indicated in association with the corresponding CVE identifier) in a catalog of known fixes, the data security system may lower the generated combined CVE risk score as there is a known corrective action to reduce the risk of the CVE.

The data security system may identify a presence of CVEs within the computing assets monitored by the data security system. For example, the data security system may scan for the computing objects associated with the CVEs in the computing assets monitored by the data security system. For a CVE identified within a computing asset monitored by the data security system, the data security system may generate a context-specific CVE risk score, based on the generated combined CVE risk score for the CVE and contextual information associated with the computing asset at which the CVE is identified. For example, if the computing asset stores or has access to sensitive information such as personally identifiable information, company trade secrets, or other confidential data, the context-specific CVE risk score may be increased. As another example, the context-specific CVE risk score may be based on which user accounts or groups of user accounts of an entity (e.g., an organization) have access to the computing asset. For example, the context-specific CVE risk score may be higher for a computing asset accessible to multiple groups of user accounts as compared to a computing asset accessible to an administrative user account only for an entity.

Generating combined CVE risk scores from multiple CVE sources may enable administrative users and/or security teams of an entity that uses the data security system to identify which CVEs are most likely to have a high impact on information security, and therefore to focus resources to most efficiently reduce risk associated with CVEs. Further, by generating context-specific CVE risk scores, administrative users and/or security teams of an entity that uses the data security system to identify which computing assets are most vulnerable, and therefore to focus resources on to most efficiently reduce risk associated with CVEs.

Aspects of the disclosure are initially described in the context of a computing environment. Aspects of the disclosure are further illustrated by and described with reference to a CVE risk score generation diagram, user interface (UI) views, process flows, apparatus diagrams, system diagrams, and flowcharts that relate to CVE scaling.

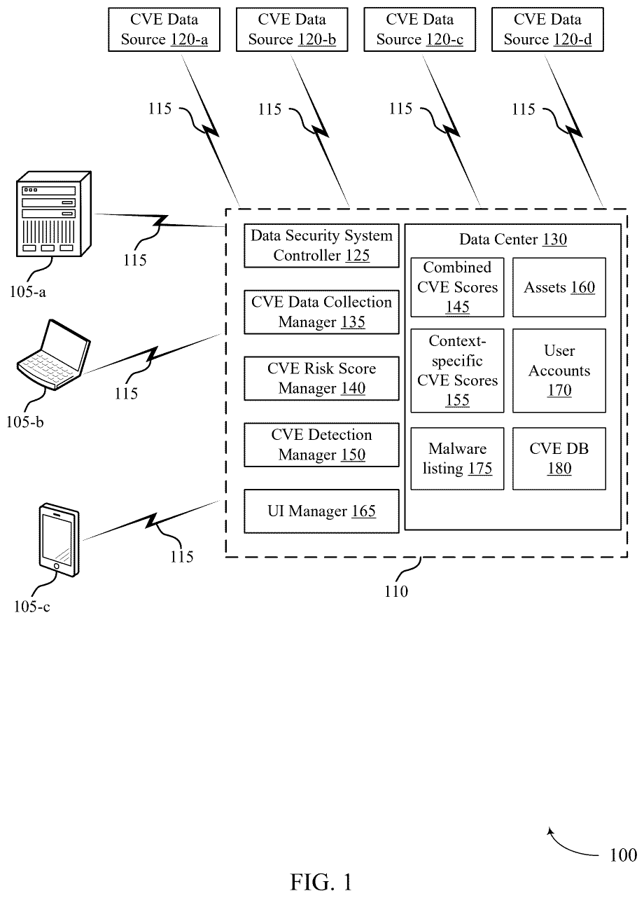

FIG. 1 illustrates an example of a computing environment 100 that supports CVE scaling in accordance with various aspects of the present disclosure. The computing environment 100 includes one or more computing assets 105 (e.g., a computing asset 105-a, a computing asset 10-b, and a computing asset 105-c) that are monitored or protected by a data security system 110. Although shown as three computing assets 105, the data security system 110 may monitor any quantity of computing assets. The data security system 110 may communicate with the one or more computing assets 105 via communication links 115 (e.g., via a network connection). For example, the network connect may implement transfer control protocol and internet protocol (TCP/IP), such as the Internet, or may implement other network protocols. For example, the communication links 115 may include aspects of one or more wired networks (e.g., the Internet), one or more wireless networks (e.g., cellular networks), or any combination thereof. The communication links 115 may include aspects of one or more public networks or private networks, as well as secured or unsecured networks, or any combination thereof. The communication links 115 also may include any quantity of communications links and any quantity of hubs, bridges, routers, switches, ports or other physical or logical network components.

As described herein, a computing asset 105 may be any device, physical or virtual, capable of analyzing, storing, generating, and transmitting or receiving data. For example, a computing asset 105 may be a desktop computer, an access point, a personal digital assistant (PDA), a laptop computer, a tablet computer, a smartphone, a server, a collection of servers, a database, a data store, a virtual machine, or any combination thereof.

For example, a virtual machine may run various applications, such as a database server, an application server, or a web server. For example, a server may be used to host (e.g., create, manage) one or more virtual machines, and a computing system manager may of the server manage a virtualized infrastructure within a computing system and perform management operations associated with the virtualized infrastructure. A computing system manager may manage the provisioning of virtual machines running within the virtualized infrastructure and provide an interface to a computing asset 105 interacting with the virtualized infrastructure. For example, the computing system manager may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of a disk of a computing system, the memory of a computing system, the processor of a computing system, the network interface of a computing system, the data storage device of a computing system, or any combination thereof in support of running the various applications. Storage resource that are virtualized may be accessed by applications as a virtual disk.

The data security system 110 may be implemented on one or more servers. The data security system 110 may include a data center 130 (e.g., one or more databases) that may include one or more servers. For example, a server may allow a client (e.g., a computing asset 105 or the data security system controller 125) to download information or files (e.g., executable, text, application, audio, image, or video files) from the server, to upload such information or files to the server, or to perform a search query related to particular information stored by the server. In general, a server may refer to one or more hardware devices that act as the host in a client-server relationship or a software process that shares a resource with or performs work for one or more clients The data center 130 may be used for data storage, management, and processing. The data center 130 may utilize multiple redundancies for security purposes. In some cases, the data stored at data center 130 may be backed up by copies of the data at a different data center (not pictured).

The data security system 110 may include a data security system controller 125, a CVE data collection manager 135, a CVE risk score manager 140, a CVE detection manager 150, and a UI manager 165. The data security system controller 125 may manage operation of the data security system 110, including the data center 130, the CVE data collection manager 135, the CVE risk score manager 140, the CVE detection manager 150, and/or the UI manager 165. Though illustrated as a separate entity within the data security system 110, the data security system controller 125 may in some cases be implemented (e.g., as a software application) by one or more of servers of the data center 130. Though illustrated as a separate entities, one or more of the CVE data collection manager 135, the CVE risk score manager 140, the CVE detection manager 150, and/or the UI manager 165 may be implemented (e.g., as a software application) by the data security system controller 125.

In some examples, a computing asset 105 may be a user device that may be used to input information to or receive information from the data security system 110. For example, a user of the computing asset 105-b may provide user inputs via the computing asset 105-b, which may result in commands, data, or any combination thereof being communicated via the communication link 115 to the data security system 110. Additionally, or alternatively, a computing asset 105 may output (e.g., display) data or other information received from the data security system 110. A user of a computing asset 105 may, for example, use the computing asset 105 to interact with one or more UIs (e.g., graphical user interfaces (GUIs)) to operate or otherwise interact with the data security system 110.

In some examples, the data security system 110, or aspects thereof, may be implemented within one or more cloud computing environments, which may alternatively be referred to as cloud environments. Cloud computing may refer to Internet-based computing, where shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the data security system 110, or aspects thereof, for example, through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing assets 105 over the communication links 115). IaaS may refer to a service in which physical computing resources are used to instantiate one or more virtual machines, the resources of which are made available to one or more client devices over a network (e.g., to one or more computing assets 105 over the communication links 115)

As described herein, the data security system 110 may provide data/information security services to the computing assets 105. For example, the computing assets 105 may be associated with one or more customers of the data security system 110. For example, the data security system 110 may store (e.g., in the data center 130), a listing of known malware 175. The data security system 110 may scan the computing assets 105 (e.g., periodically or on-demand) for malware based on the listing of known malware 175.

As another example, the CVE data collection manager 135 may collect (e.g., may receive) CVE risk information from one or more CVE data sources 120. For example, the CVE data sources 120 may include a first CVE data source 120-a, a second CVE data source, a third CVE data source 120-c, and/or a fourth CVE data source 120-d. For example, the first CVE data source 120-a may be the NVD which may provide listing of CVE identifiers, associated respective computing objects subject to a vulnerability, and associated CVSS risk scores. As another example, the second CVE data source 120-b may be the KEV catalog provided by the CISA. As another example, the third CVE data source 120-c may provide respective EPSS scores along with CVE identifiers. As another example, the fourth CVE data source 120-d may provide a catalog of known corrective actions or fixes associated with respective CVE identifiers. Although shown as four CVE data sources, the data security system 110 may receive CVE risk information from any quantity of CVE data sources.

In some examples, the data security system 110 may store CVE information received from the CVE data sources (e.g., CVE identifiers, the associated computing objects subject to the associated vulnerability, the associated CVSS risk scores, the associated EPSS scores, whether the associated CVEs are subject to a KEV, and/or the known corrective actions for the associated CVEs) in a CVE database 180 (e.g., in the data center 130). The data security system 110 may scan the computing assets 105 (e.g., periodically or on-demand) for computing objects associated with CVE identifiers stored in the CVE database 180.

The CVE risk score manager 140 may generate a combined CVE risk score for each CVE identifier based on the risk information associated with each CVE identifier received from the multiple CVE data sources 120. For example, the combined CVE risk score for a particular CVE may be based on the CVSS, the EPSS, whether the CVE appears in the KEV catalog, and/or whether there is a known corrective action for the CVE in a catalog of known fixes. For example, CVSS and/or EPSS scores may be positively correlated with the generated combined CVE risk score. For example, the more severe a risk is for a particular CVE (e.g., as indicated by a higher CVSS score), or the higher the probability the vulnerability will actually be exploited (e.g., as indicated by the EPSS score), the higher the generated combined CVE risk score may be for the particular CVE. As another example, the generated combined CVE risk score may be increased if the CVE identifier appears in the KEV catalog (e.g., if a vulnerability associated with a CVE has actually been exploited, the generated combined CVE risk score for that CVE may be increased). As another example, if the data security system 110 identifies a corrective action indicated for the particular CVE (e.g., indicated in association with the corresponding CVE identifier) in a catalog of known fixes, the data security system may lower the generated combined CVE risk score as there is a known corrective action to reduce the risk of the CVE. The CVE risk score manager 140 may store the combined CVE risk scores for each CVE identifier in a combined CVE risk score listing 145, for example, in the data center 130. In some examples, the generated combined CVE risk scores may be scaled (e.g., within a range between 0 and 10).

When the CVE detection manager 150 detects the presence of a computing object associated with a CVE in a computing asset 105, the CVE detection manager 150 may identify contextual information associated with the CVE in the computing asset 105. The CVE risk score manager 140 may generate a context-specific CVE risk score for each instance of a CVE detected on a computing asset 105. The CVE risk score manager 140 may store the context-specific CVE risk scores for each instance of a detected CVE identifier in a context-specific CVE score listing 155, for example, in the data center 130. As an example, the contextual information may include whether the computing asset 105 stores or has access to sensitive information (e.g., PII, organization trade secrets, or other confidential information). For example, the context-specific CVE risk score may be increased as compared to the corresponding combined CVE risk score if the computing asset 105 on which the instance of the CVE was detected stores or has access to sensitive information. As another example, the contextual information may include which user accounts or groups of user accounts have permissions to access the computing asset as well as the type of access (e.g., read-only or read-write). For example, the context-specific CVE risk score may be increased as more user accounts have access to a computing asset (e.g., context-specific CVE risk scores may be positively correlated with increased access permissions). For example, the data security system 110 may store a listing of user accounts 170 associated with a customer of the data security system. The listing of user accounts 170 may indicate which user accounts have access to which computing assets. As another example, the contextual information may include a device type of the computing asset. For example, mobile computing assets 105 such as laptops and smartphones which may connect to unsecured networks may be riskier than fixed assets such as desktop computers or servers in an office setting. For example, the data security system 110 may store a listing of computing assets 160 associated with a customer of the data security system 110.

An administrative user of the data security system 110 may view the generated combined CVE risk scores stored in the combined CVE risk score listing 145 as well as CVE information stored in the CVE database 180 and/or information regarding the instances of the CVEs detected in the computing assets 105 as well as the context-specific CVE risk scores stored in the combined CVE risk score listing 145 as well as CVE information stored in the CVE database 180. For example, the UI manager 165 of the data security system 110 may cause display, at a UI of a computing asset 105, of information regarding generated combined CVE risk scores. Accordingly, an administrative user associated with the computing assets may identify risks associated with the presence of computing objects associated with the CVEs on the computing assets and may deploy resources to manage the risks based on the severity of the risks (e.g., as indicated by the context-specific CVE risk scores and/or the combined CVE risk scores).

It should be appreciated by a person skilled in the art that one or more aspects of the disclosure may be implemented in a computing environment 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

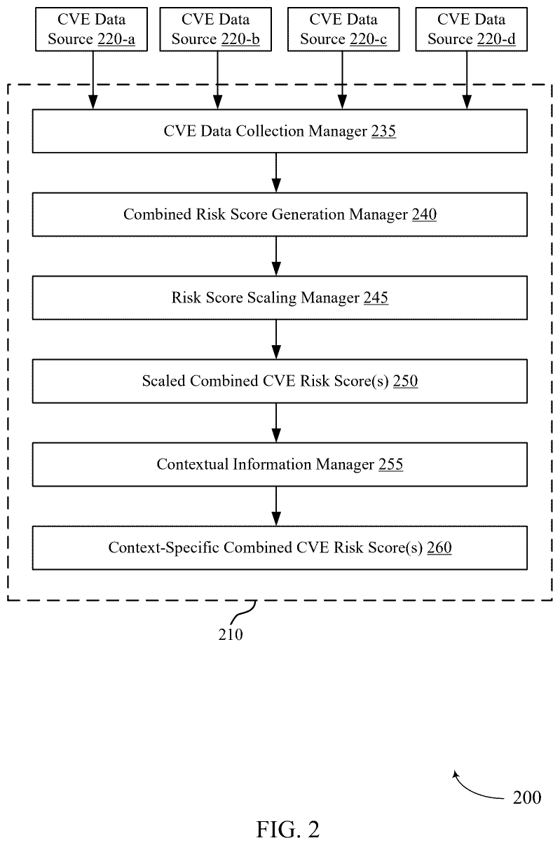

FIG. 2 shows an example of a combined CVE risk score generation diagram 200 that supports CVE scaling in accordance with aspects of the present disclosure. The combined CVE risk score generation diagram 200 may implement or may be implemented by aspects of the computing environment 100. For example, the combined CVE risk score generation diagram 200 may include a first CVE data source 220-a, a second CVE data source 220-b, a third CVE data source 220-c, and a fourth CVE data source 220-d, which may be examples of CVE data sources 120 as described herein. The combined CVE risk score generation diagram 200 may include a data security system 210, which may be an example of a data security system 110 as described herein. The data security system 210 may include a CVE data collection manager 235, which may be an example of a CVE data collection manager 135 as described herein.

The CVE data collection manager 235 may collect (e.g., may receive) CVE risk information from one or more CVE data sources 220. For example, the CVE data sources 220 may include a first CVE data source 220-a, a second CVE data source, a third CVE data source 220-c, and/or a fourth CVE data source 220-d. For example, the first CVE data source 220-a may be the NVD which may provide listing of CVE identifiers, associated respective computing objects subject to a vulnerability, and associated CVSS risk scores. As another example, the second CVE data source 220-b may be the KEV catalog provided by CISA. As another example, the third CVE data source 220-c may provide respective EPSS scores along with CVE identifiers. As another example, the fourth CVE data source 220-d may provide a catalog of known corrective actions or fixes associated with respective CVE identifiers. Although shown as fourth CVE data sources, the data security system 110 may receive CVE risk information from any quantity of CVE data sources.

The data security system 210 may include a combined risk score generation manager 240. The combined risk score generation manager 240 may combine the risk information collected by the CVE data collection manager 235 from the multiple CVE data sources 220 for each CVE identifier and may generate a raw combined CVE risk score for each CVE identifier. For example, the raw combined CVE risk score for a particular CVE may be based on the CVSS, the EPSS, whether the CVE appears in the KEV catalog, and/or whether there is a known corrective action for the CVE in a catalog of known fixes. For example, CVSS and/or EPSS scores may be positively correlated with the generated raw combined CVE risk score. For example, the more severe a risk is for a CVE (e.g., as indicated by a higher CVSS score), or the higher the probability the vulnerability will actually be exploited (e.g., as indicated by the EPSS score), the higher the generated raw combined CVE risk score may be for the CVE. As another example, the generated raw combined CVE risk score may be increased if the CVE identifier appears in the KEV catalog (e.g., if a vulnerability associated with a CVE has actually been exploited, the generated combined CVE risk score for that CVE may be increased). As another example, if the data security system 210 identifies a corrective action indicated for the particular CVE (e.g., indicated in association with the corresponding CVE identifier) in a catalog of known fixes, the data security system 210 may lower the generated raw combined CVE risk score as there is a known corrective action to reduce the risk of the CVE.

The data security system 210 may include a risk score scaling manager 245. The risk score scaling manager 245 may scale the generated raw combined CVE risk score output by the combined risk score generation manager 240 to a value within a particular range (e.g., between 0 and 10). Accordingly, the output of the risk score scaling manager 245 may be a scaled combined CVE risk score 250 for each CVE identifier. For example, a higher scaled score may indicate a riskier CVE. For example, the risk score scaling manager 245 may use probability cumulative distribution scaling, logistic/sigmoid (e.g., neural network) scaling, and/or principal component analysis (PCA) scaling to scale the generated raw combined CVE risk scores to scaled combined CVE risk scores 250. The data security system 210 may store the scaled combined CVE risk scores 250, for example, in a data center 130, as described herein. Accordingly, a user of the data security system 210 may view and/or search for CVEs based on the scaled combined CVE risk scores 250 to identify which CVEs are the most risky and/or which CVEs are less likely to be exploited/cause data interruption. In some examples, the data security system may alternatively or also store the raw combined CVE risk scores generated by the combined risk score generation manager 240.

In some examples, the data security system 210 may include a contextual information manager 255, which may receive contextual information associated with actual detection of CVEs in computing assets 105 monitored by the data security system 210. As an example, the contextual information may include whether the computing asset 105 stores or has access to sensitive information (e.g., PII, organization trade secrets, or other confidential information). The contextual information manager 255 may use the contextual information associated with actual detection of CVEs in computing assets to generate context-specific combined CVE risk scores 260. For example, a context-specific combined CVE risk score 260 may be increased as compared to the corresponding scaled combined CVE risk score 250 if a computing asset on which the instance of the CVE was detected stores or has access to sensitive information. As another example, the contextual information may include which user accounts or groups of user accounts have permissions to access the computing asset as well as the type of access (e.g., read-only or read-write). For example, the context-specific combined CVE risk score 260 may be increased as more user accounts have access to a computing asset (e.g., context-specific CVE risk scores may be negatively correlated with increased access permissions). As another example, the contextual information may include a device type of the computing asset. For example, mobile computing assets 105 such as laptops and smartphones which may connect to unsecured networks may be riskier than fixed assets such as desktop computers or servers in an office setting.

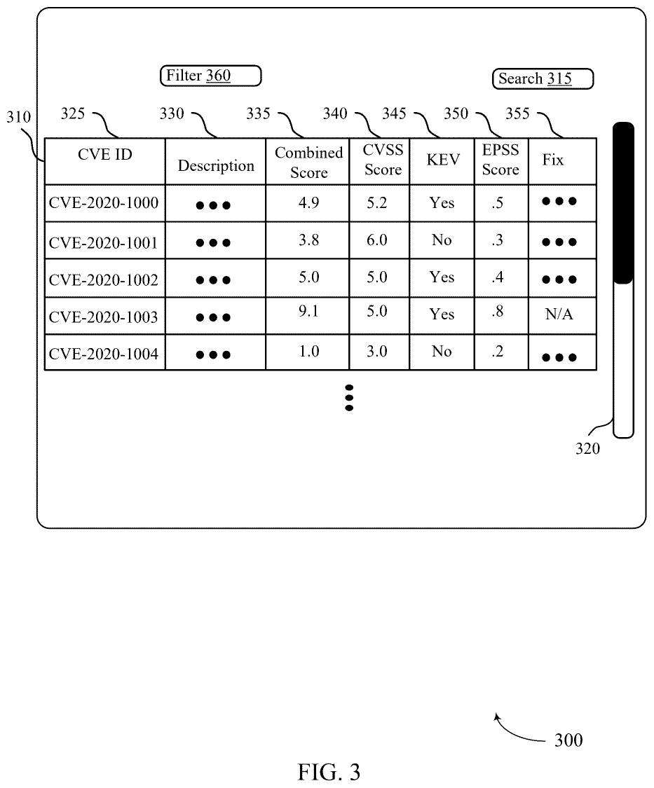

FIG. 3 shows an example of a UI view 300 that supports CVE scaling in accordance with aspects of the present disclosure. The UI view 300 may implement or may be implemented by aspects of the computing environment 100 or the combined CVE risk score generation diagram 200. For example, the UI view 300 may be presented on a display of a computing asset 105 as described herein, or any other computing device that may communicate with a data security system 110 or a data security system 210 as described herein.

The UI view 300 shows a view of combined CVE risk scores generated by a data security system (e.g., a data security system 110 or a data security system 210) using risk information collected from multiple CVE data sources (e.g., CVE data sources 120 or CVE data sources 220 as described herein). For example, the UI view 300 may display a table 310 which may include multiple columns. A CVE identifier column 325 may display a CVE identifier and a description column 330 may display a description of the corresponding CVE (e.g., each row of the table 310 may correspond to information associated with the same CVE). For example, the description in the description column 330 may be received from the NVD. For example, the description may indicate the affected computing object and vulnerability associated with the CVE identifier indicated in the CVE identifier column 325. A combined score column 335 may list the combined risk score for the CVE (e.g., the scaled combined CVE risk score 250 or the combined CVE risk scores from the combined CVE risk score listing 145). The table 310 may also include other risk information collected from the CVE data sources. For example, a CVSS column 340 may indicate the CVSS score for the CVE provided by the NVD. As another example, a KEV column 345 may indicate whether the CVE associated with the given CVE identifier appears in the KEV catalog. As another example, an EPSS column 350 may indicate the EPSS score for the CVE provided by FIRST. As another example, the Fix column 355 may indicate a known corrective action for the CVE (if available) as indicated by a known corrective action catalog (e.g., from CVE.org).

In some examples, a user may filter or sort by particular columns. For example, a user may select the CVE identifier column 325 to sort by CVE identifier. As another example, the user may select the combined score column 335 to sort by combined score for the CVE (e.g., to view the riskiest or least risky CVEs). As another example, the user may select the CVSS column 340 to sort by CVSS scores. As another example, the user may select the KEV column 345 to sort by CVEs that have actually been exploited. As another example, the user may select the EPSS column 350 to sort by EPSS scores. As another example, the user may select the FIX column 355 to sort by CVEs with or without known corrective actions. The UI view 300 may include a scroll bar 320 to scroll through the CVEs (e.g., the data security system may include information on thousands or millions of CVEs). The UI view 300 may include a search field 315 (e.g., to search for a specific CVE identifier). The UI view 300 may include a filter field 360, for example, to search for CVEs within a particular data range, to search for CVEs within a particular combined risk score range (e.g., above 5.0, between 3.0 and 5.7, etc.), or to search for CVEs within any particular range of any particular field.

As shown in FIG. 3, the combined risk score for a CVE may be based on the risk information collected from the multiple data sources. For example, CVE-2020-1002 and CVE-2020-1003 may each have a CVSS score of 5.0 and may each appear in the KEV catalog. CVE-2020-1002, however, may have a lower EPSS score (e.g., 0.4 as compared to 0.8 for CVE-2020-1003), and CVE-2020-1002 may have a known corrective action while CVE-2020-1003 may not. Accordingly, CVE-2020-1002 may have a lower combined risk score (5.0) than CVE-2020-1003 (9.1).

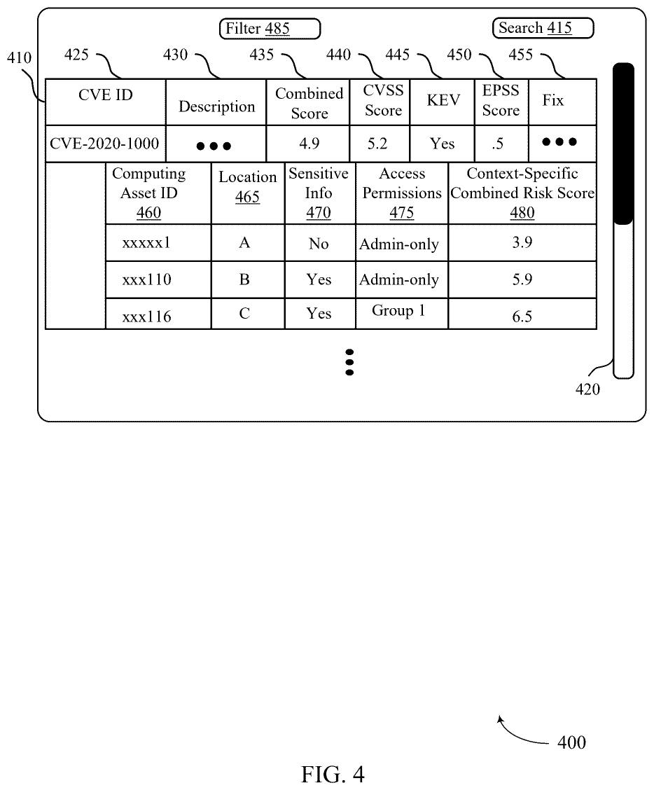

In some examples, a user may select a CVE (e.g., may select a row of the table 310) to view more information regarding the CVE, for example, as shown in FIG. 4

FIG. 4 shows an example of a UI view 400 that supports CVE scaling in accordance with aspects of the present disclosure. The UI view 400 may implement or may be implemented by aspects of the computing environment 100 or the combined CVE risk score generation diagram 200. The UI view 400 may be presented on a display of a computing asset 105 as described herein, or any other computing device that may communicate with a data security system 110 or a data security system 210 as described herein.

The UI view 400 shows a view of a combined CVE risk score generated by a data security system (e.g., a data security system 110 or a data security system 210) using risk information collected from multiple CVE data sources (e.g., CVE data sources 120 or CVE data sources 220 as described herein) for a particular CVE. For example, a user may select a particular CVE for which to view more information from the UI view 300 as described with reference to FIG. 3. For example, the UI view 400 may display a table 410 which may include multiple columns. A CVE identifier column 425 may display a CVE identifier for the selected CVE and a description column 430 may display a description of the corresponding CVE. For example, the description in the description column 430 may be received from the NVD. For example, the description may indicate the affected computing object and vulnerability associated with the CVE identifier indicated in the CVE identifier column 425. A combined score column 435 may list the combined risk score for the CVE (e.g., the scaled combined CVE risk score 250 or the combined CVE risk scores from the combined CVE risk score listing 145). The table 410 may also include other risk information collected from the CVE data sources. For example, a CVSS column 440 may indicate the CVSS score for the CVE provided by the NVD. As another example, a KEV column 445 may indicate whether the CVE associated with the selected CVE appears in the KEV catalog. As another example, an EPSS column 450 may indicate the EPSS score for the CVE provided by FIRST. As another example, the FIX column 455 may indicate a known corrective action for the CVE (if available) as indicated by a known corrective action catalog (e.g., from CVE.org).

A computing asset identifier column 460 may indicate computing assets 105 monitored by the data security system (e.g., a data security system 110 or a data security system 210) at which the CVE is detected. For example, the data security system may detect the presence of a computing object associated with the CVE on the computing assets 105 listed in the computing asset identifier column 460. A location column 465 may indicate a location of the corresponding computing asset listed in the computing asset identifier column 460. A sensitive information column 470 may indicate whether sensitive information is stored on or accessible to the computing assets listed in the computing asset identifier column 460. An access permission column 475 may indicate access permissions for the computing assets listed in the computing asset identifier column 460. For example, the access permission column 475 may indicate whether the computing assets are accessible to administrative users only, may indicate particular user accounts that may access the computing asset, or may indicate groups of user accounts (e.g., engineering, information technology, human resources), that may access the computing asset. A context-specific combined CVE risk score column 480 may indicate the context-specific combined CVE risk score for the instance of the CVE on the specific computing asset. For example, the context-specific combined CVE risk score may be the context-specific combined CVE risk scores 260 or from the context-specific CVE score listing 155 as described herein.

The UI view 400 may include a scroll bar 420 to scroll through the computing assets on which the CVE is detected. The UI view 400 may include a search field 415 to search for particular computing assets and/or locations. In some examples, a user may filter or sort by particular columns. For example, a user may select the computing asset identifier column 460 to sort computing assets by computing asset identifier. As another example, a user may select the location column 465 to sort by computing asset locations. As another example, the user may select the sensitive information column 470 to sort by computing assets with or without sensitive information. As another example, the user may select the access permission column 475 to sort by access permissions. As another example, the user may select the context-specific combined CVE risk score column 480 to sort by context-specific combined CVE risk scores (e.g., to view the computing assets on which the CVE is the highest risk to be exploited). The UI view 400 may include a filter field 485, for example, to search for computing assets at a particular location, within a particular context-specific combined CVE risk scores, that do or do not include sensitive information, and/or with specific access permissions.

As described herein, the context-specific combined CVE risk score may be based on the combined score (e.g., as shown in the combined score column 435) scaled for contextual information associated with the computing asset on which the CVE is detected. For example, the combined risk score for the CVE-2020-1000 may be 4.9. Computing asset xxxxx1 may not include or have access to sensitive information and may be accessible to administrative users only, and accordingly the contextual information may indicate that the risk of the CVE being exploited on computing asset xxxxx1 is reduced, thus the context-specific combined CVE risk score may be 3.9. Computing asset xxx110 may include or may have access to sensitive information and may be accessible to administrative users only, and accordingly the contextual information may indicate that the risk of the CVE being exploited on computing asset xxx110 is higher than the risk of computing asset xxxxx1 being exploited, thus the context-specific combined CVE risk score may be 5.9 (e.g., increased with respect to 4.9 based on the inclusion or access to sensitive information). Computing asset xxx116 may include or may have access to sensitive information and may be accessible to users accounts of Group 1 (e.g., which may include a large quantity of user accounts), and accordingly the contextual information may indicate that the risk of the CVE being exploited on computing asset xxx116 is higher than the risk of computing asset xxxxx1 and computing asset xxx110 being exploited, thus the context-specific combined CVE risk score may be 6.5 (e.g., increased with respect to 4.9 based on the inclusion or access to sensitive information and the access to group 1).

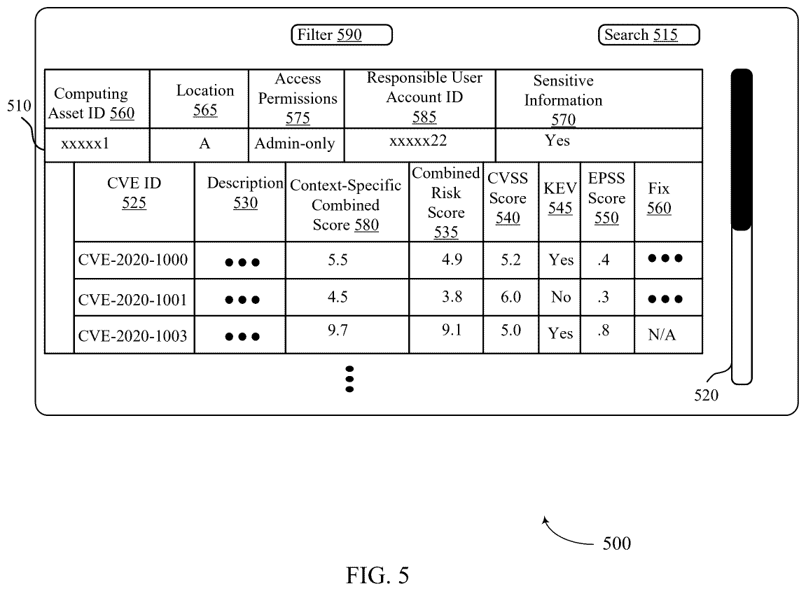

FIG. 5 shows an example of a UI view 500 that supports CVE scaling in accordance with aspects of the present disclosure. The UI view 500 may implement or may be implemented by aspects of the computing environment 100 or the combined CVE risk score generation diagram 200. The UI view 500 may be presented on a display of a computing asset 105 as described herein, or any other computing device that may communicate with a data security system 110 or a data security system 210 as described herein.

The UI view 500 shows a view of CVEs detected on a particular computing asset. For example, a user may select a particular computing asset 105 via a search field 515. The UI view 500 may display a table 510 which may include multiple columns. For example, the table 510 may include a computing asset identifier column 560 which may indicate the computing asset identifier for the selected computing asset. A location column 565 may indicate a location of the computing asset 105. A sensitive information column 570 may indicate whether sensitive information is stored on or accessible to the computing asset. An access permission column 575 may indicate access permissions for the computing asset. For example, the access permission column 575 may indicate whether the computing asset is accessible to administrative users only, may indicate particular user accounts that may access the computing asset, or may indicate groups of user accounts (e.g., engineering, information technology, human resources), that may access the computing asset. A responsible user account identifier column 585 may indicate a particular user account assigned to the computing asset. For example, if the computing asset is a laptop or a smartphone, the responsible user account identifier column 585 may identify the user account assigned to the computing asset (e.g., the primary user of the laptop or smartphone).

A CVE identifier column 525 may display CVE identifiers of CVEs detected on the selected computing asset (e.g., computing asset xxxxx1) and a description column 530 may display a description of the corresponding CVE (e.g., each row of the table may correspond to information associated with the same CVE). For example, the description may be received from the NVD. For example, the description may indicate the affected computing object and vulnerability associated with the CVE identifier indicated in the CVE identifier column 525. A combined score column 535 may list the combined risk score for the CVE (e.g., the scaled combined CVE risk score 250 or the combined CVE risk scores from the combined CVE risk score listing 145). The table 510 may also include other risk information collected from the CVE data sources. For example, a CVSS column 540 may indicate the CVSS score for the CVE provided by the NVD. As another example, a KEV column 545 may indicate whether the CVE associated with the given CVE identifier appears in the KEV catalog. As another example, an EPSS column 550 may indicate the EPSS score for the CVE provided by FIRST. As another example, the Fix column 555 may indicate a known corrective action for the CVE (if available) as indicated by a known corrective action catalog (e.g., from CVE.org). The table 510 may also include a context-specific combined CVE risk score column 580 which may indicate the context-specific combined CVE risk scores for the instances of the CVEs detected on the specific computing asset.

For example, as the computing asset includes or has access to sensitive information, the context-specific combined CVE risk scores for each of the CVEs may be higher than the combined risk scores for the CVEs (e.g., 5.5 versus 4.9 for the CVE-2020-1000, 4.5 versus 3.8 for the CVE-2020-1001, and 9.7 versus 9.1 for the CVE-2020-1003). The UI view 500 may include a scroll bar 520 to scroll through the CVEs detected on the computing asset. The UI view 500 may include a search field 515 (e.g., to search for a specific CVE identifier). The UI view 500 may include a filter field 590, for example, to search for CVEs within a particular data range, to search for CVEs within a particular combined risk score range or context-specific combined CVE risk score (e.g., above 5.0, between 3.0 and 5.7, etc.), or to search for CVEs within any particular range of any particular field.

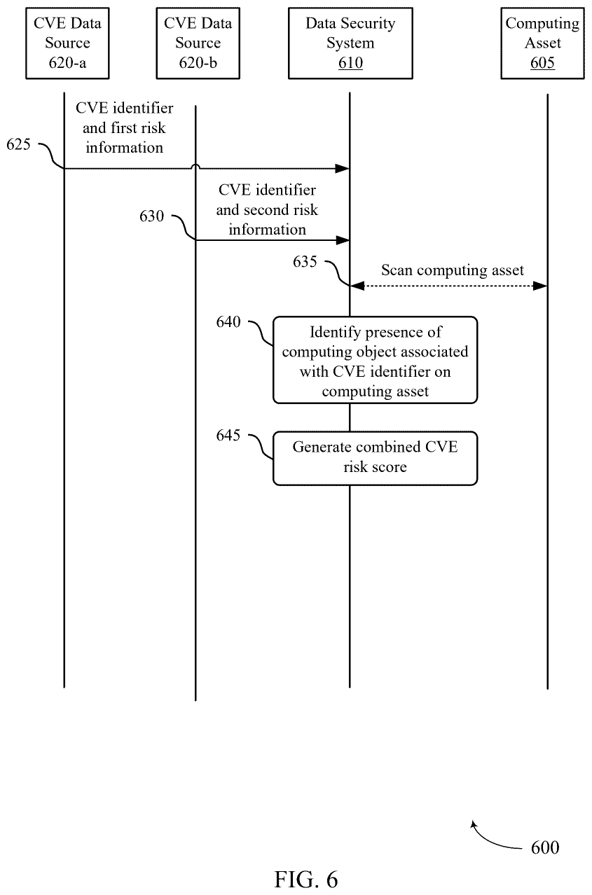

FIG. 6 shows an example of a process flow 600 that supports CVE scaling in accordance with aspects of the present disclosure. The process flow 600 may implement or may be implemented by one or more aspects of the computing environment 100, the combined CVE risk score generation diagram 200, the UI view 300, the UI view 400, or the UI view 500. For example, the process flow 600 may include a data security system 610, which may be an example of a data security system 110 or a data security system 210 as described herein. The process flow 600 may include a computing asset 605, which may be an example of a computing asset 105 as described herein. The process flow 600 may include a first CVE data source 620-a and a second CVE data source 620-b, which may be examples of CVE data sources 120 or CVE data sources 220 as described herein. In the following description of the process flow 600, operations between the data security system 610, the computing asset 605, the first CVE data source 620-a, and the second CVE data source 620-b may be added, omitted, or performed in a different order (with respect to the exemplary order shown).

At 625, the data security system 610 may receive, from the first CVE data source 620-a, an indication of a CVE identifier and first risk information associated with the CVE identifier. The CVE identifier may be associated with an information security vulnerability or exposure of a computing object. For example, the first risk information may include a description of the CVE that may indicate a computing object associated with the CVE identifier.

At 630, the data security system 610 may receive, from the second CVE data source 620-b, an indication of the CVE identifier and second risk information associated with the CVE identifier.

At 640, the data security system 610 may identify a presence of the computing object on the computing asset 605. The data security system 610 may also identify contextual information associated with the presence of the computing object. For example, the contextual information may include an access permission level associated with the computing asset 605, a quantity of users with access to the computing asset 605, a storage location of the computing asset 605, a presence of sensitive information on the computing asset 605, or a combination thereof.

At 645, the data security system 610 may generate a combined CVE risk score for the presence of the computing object on the computing asset 605 based on the first risk information, the second risk information, and the contextual information. For example, the combined CVE risk score for the presence of the computing object on the computing asset 605 may be a context-specific combined CVE risk score as described herein (e.g., a context-specific combined CVE risk score 260).

In some examples, at 635, the data security system 610 may perform a scan of the computing asset 605 (e.g., may scan the files and computing objects stored on the computing asset 605). In such examples, the data security system 610 may identify the presence of the computing object on the computing asset 605 at 640 based on performing the scan at 635. In some examples, at 640 the data security system 610 may receive (e.g., from an administrative user of the data security system or from a customer account of the data security system), an indication of the presence of the computing object on the computing asset 605 and the contextual information.

In some examples, the first risk information may be a risk severity score (e.g., a CVSS score), and the risk severity score may be positively correlated with the combined CVE risk score. In some examples, the first risk information may be a vulnerability exploitation probability score (e.g., an EPSS score), and the vulnerability exploitation probability score may be positively correlated with the combined CVE risk score.

In some examples, the data security system 610 may increase the combined CVE risk score based on the first risk information including an indication that the CVE identifier is associated with a KEV. For example, the first CVE data source may be a KEV catalog. In some examples, the data security system 610 may decrease the combined CVE risk score based on the first risk information being an absence of the CVE identifier in a KEV catalog, where the first CVE data source may be the KEV catalog.

In some examples, the data security system 610 may decrease the combined CVE risk score based on the first risk information including an indication of a corrective action associated with the CVE identifier in a known corrective action catalog, where the first CVE data source may be the known corrective action catalog. In some examples, the data security system 610 may cause presentation, via a UI associated with a client or customer account of the data security system 610, an indication of the CVE identifier in association with the computing asset 605, and the corrective action. For example, a CVE maybe less risky if there is a known corrective action for the CVE. For example, the data security system may present corrective actions for CVEs, if available. In some examples, the data security system 610 may increase the combined CVE risk score based on the first risk information including an absence of a corrective action associated with the CVE identifier in a known corrective action catalog, where the first CVE data source may be the known corrective action catalog.

In some examples, the data security system 610 may generate a first CVE risk score associated with the CVE identifier based on the first risk information and the second risk information (e.g., a scaled combined CVE risk score 250), and the data security system 610 may scale the first CVE risk score based on the contextual information to generate the combined CVE risk score. In some examples, the data security system 610 may identify a second presence of the computing object on a second computing asset and second contextual information associated with the second presence of the computing object. The data security system 610 may scale the first CVE risk score based on the second contextual information to generate a second combined CVE risk score associated with the second presence of the computing object on the second computing asset.

In some examples, the data security system 610 may receive, from a third CVE data source, an indication of the CVE identifier and third risk information associated with the CVE identifier. The data security system 610 may generate the combined CVE risk score for the presence of the computing object on the computing asset 605 is based on the third risk information in addition to the first risk information and the second risk information. For example, the data security system may collect CVE risk information from any quantity of CVE data sources and may use the collected CVE risk information to generate a combined CVE risk score.

In some examples, the data security system 610 may generate a raw combined CVE risk score for the presence of the computing object on the computing asset 605 based on the first risk information, the second risk information, and the contextual information. The data security system 610 may scale the raw combined CVE risk score to a value within a scaled range, and the combined CVE risk score may be the value within the scaled range. In some examples, the data security system 610 may scale raw combined CVE risk score using at least one of probability cumulative distribution scaling, logistic scaling, sigmoid scaling, or principal component analysis scaling.

In some examples, the data security system 610 may cause presentation, via a UI associated with a client or customer account of the data security system 610, an indication of the CVE identifier in association with the computing asset 605, and the combined CVE risk score.

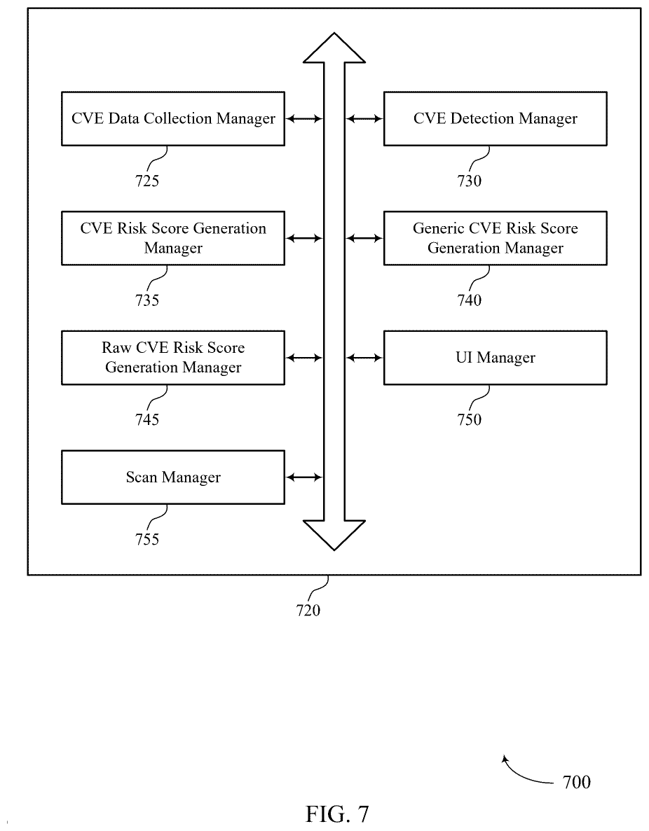

FIG. 7 shows a block diagram 700 of a Data Security System 720 that supports CVE scaling in accordance with aspects of the present disclosure. The Data Security System 720 may be an example of aspects of a Data Security System as described with reference to FIGS. 1 through 6. The Data Security System 720, or various components thereof, may be an example of means for performing various aspects of CVE scaling as described herein. For example, the Data Security System 720 may include a CVE data collection manager 725, a CVE detection manager 730, a CVE risk score generation manager 735, a generic CVE risk score generation manager 740, a raw CVE risk score generation manager 745, a UI manager 750, a scan manager 755, or any combination thereof. Each of these components, or components of subcomponents thereof (e.g., one or more processors, one or more memories), may communicate, directly or indirectly, with one another (e.g., via one or more buses). In some examples, one or more components of the data security system 720 may be implemented across one or more distributed servers or as cloud applications and may communicate with each other over network connections (e.g., via communications links 115 as described herein).

The CVE data collection manager 725 may be configured to support receiving, at a data security system and from a first CVE data source, an indication of a CVE identifier and first risk information associated with the CVE identifier, where the CVE identifier is associated with an information security vulnerability or exposure of a computing object. In some examples, the CVE data collection manager 725 may be configured to support receiving, at the data security system and from a second CVE data source, an indication of the CVE identifier and second risk information associated with the CVE identifier. The CVE detection manager 730 may be configured to support identifying, by the data security system, a presence of the computing object on a computing asset and contextual information associated with the presence of the computing object. The CVE risk score generation manager 735 may be configured to support generating, by the data security system, a combined CVE risk score for the presence of the computing object on the computing asset based on the first risk information, the second risk information, and the contextual information.

In some examples, the first risk information includes a risk severity score. In some examples, the risk severity score is positively correlated with the combined CVE risk score.

In some examples, to support generating the combined CVE risk score, the CVE risk score generation manager 735 may be configured to support increasing the combined CVE risk score based on the first risk information including an indication that the CVE identifier is associated with a KEV, where the first CVE data source includes a KEV catalog.

In some examples, the CVE risk score generation manager 735 may be configured to support decreasing the combined CVE risk score based on the first risk information including an absence of the CVE identifier in a KEV catalog, where the first CVE data source includes the KEV catalog.

In some examples, the first risk information includes a vulnerability exploitation probability score. In some examples, the vulnerability exploitation probability score is positively correlated with the combined CVE risk score.

In some examples, to support generating the combined CVE risk score, the CVE risk score generation manager 735 may be configured to support decreasing the combined CVE risk score based on the first risk information including an indication of a corrective action associated with the CVE identifier in a known corrective action catalog, where the first CVE data source includes the known corrective action catalog.

In some examples, the UI manager 750 may be configured to support presenting, via a user interface associated with a client account of the data security system, an indication of the CVE identifier in association with the computing asset, and the corrective action.

In some examples, to support generating the combined CVE risk score, the CVE risk score generation manager 735 may be configured to support increasing the combined CVE risk score based on the first risk information including an absence of a corrective action associated with the CVE identifier in a known corrective action catalog, where the first CVE data source includes the known corrective action catalog.

In some examples, to support generating the combined CVE risk score, the generic CVE risk score generation manager 740 may be configured to support generating a first CVE risk score associated with the CVE identifier based on the first risk information and the second risk information. In some examples, to support generating the combined CVE risk score, the CVE risk score generation manager 735 may be configured to support scaling the first CVE risk score based on the contextual information to generate the combined CVE risk score.

In some examples, the CVE detection manager 730 may be configured to support identifying, by the data security system, a second presence of the computing object on a second computing asset and second contextual information associated with the second presence of the computing object. In some examples, the CVE risk score generation manager 735 may be configured to support scaling the first CVE risk score based on the second contextual information to generate a second combined CVE risk score associated with the second presence of the computing object on the second computing asset.

In some examples, the CVE data collection manager 725 may be configured to support receiving, at the data security system and from a third CVE data source, an indication of the CVE identifier and third risk information associated with the CVE identifier, where generating the combined CVE risk score for the presence of the computing object on the computing asset is based on the third risk information.

In some examples, to support generating the combined CVE risk score, the raw CVE risk score generation manager 745 may be configured to support generating a raw combined CVE risk score for the presence of the computing object on the computing asset based on the first risk information, the second risk information, and the contextual information. In some examples, to support generating the combined CVE risk score, the CVE risk score generation manager 735 may be configured to support scaling the raw combined CVE risk score to a value within a scaled range, where the combined CVE risk score includes the value within the scaled range.

In some examples, to support scaling the raw combined CVE risk score, the CVE risk score generation manager 735 may be configured to support scaling the raw combined CVE risk score using at least one of probability cumulative distribution scaling, logistic scaling, sigmoid scaling, or principal component analysis scaling.

In some examples, the UI manager 750 may be configured to support presenting, via a user interface associated with a client account of the data security system, an indication of the CVE identifier in association with the computing asset, and the combined CVE risk score.

In some examples, the contextual information includes an access permission level associated with the computing asset, a quantity of user with access to the computing asset, a storage location of the computing asset, a presence of sensitive information on the computing asset, or a combination thereof.

In some examples, the scan manager 755 may be configured to support performing, by the data security system, a scan of the computing asset, where identifying the presence of the computing object on the computing asset and the contextual information is based on the scan.

In some examples, the CVE detection manager 730 may be configured to support receiving, by the data security system, an indication of the presence of the computing object on the computing asset and the contextual information, where identifying the presence of the computing object on the computing asset and the contextual information is based on the indication.

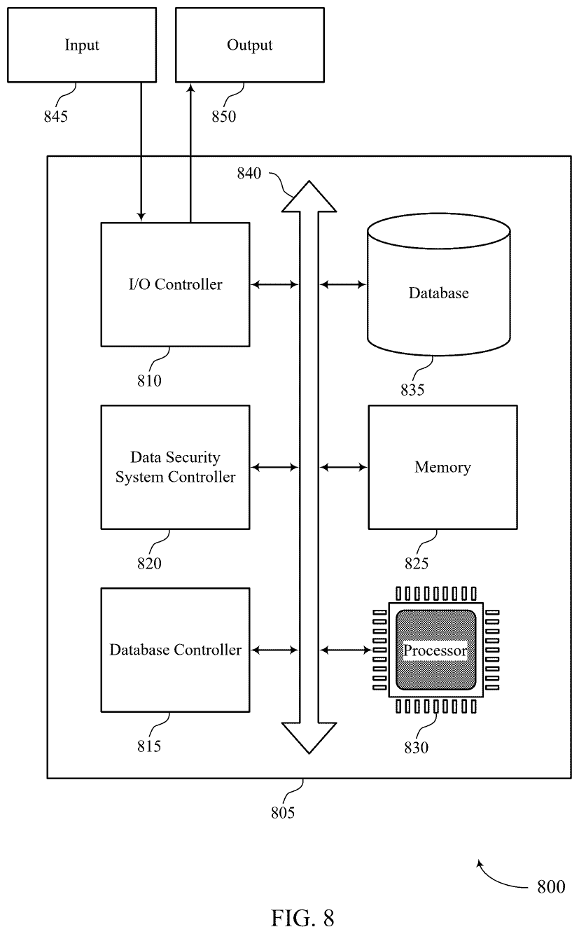

FIG. 8 shows a diagram of a system 800 including a device 805 that supports CVE scaling in accordance with aspects of the present disclosure. The device 805 may include components for bi-directional data communications including components for transmitting and receiving communications, such as a data security system controller 820, an input/output (I/O) controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting CVE scaling). The processor 830 may be an example of a single processor or multiple processors. For example, the device 805 may include one or more processors 830.

For example, the data security system controller 820 may be configured to support receiving, at a data security system and from a first CVE data source, an indication of a CVE identifier and first risk information associated with the CVE identifier, where the CVE identifier is associated with an information security vulnerability or exposure of a computing object. The data security system controller 820 may be configured to support receiving, at the data security system and from a second CVE data source, an indication of the CVE identifier and second risk information associated with the CVE identifier. The data security system controller 820 may be configured to support identifying, by the data security system, a presence of the computing object on a computing asset and contextual information associated with the presence of the computing object. The data security system controller 820 may be configured to support generating, by the data security system, a combined CVE risk score for the presence of the computing object on the computing asset based on the first risk information, the second risk information, and the contextual information.

By including or configuring the data security system controller 820 in accordance with examples as described herein, the device 805 may support techniques for improved data security, improved visualization of CVEs, and more efficient management of CVE within protected computing assets.

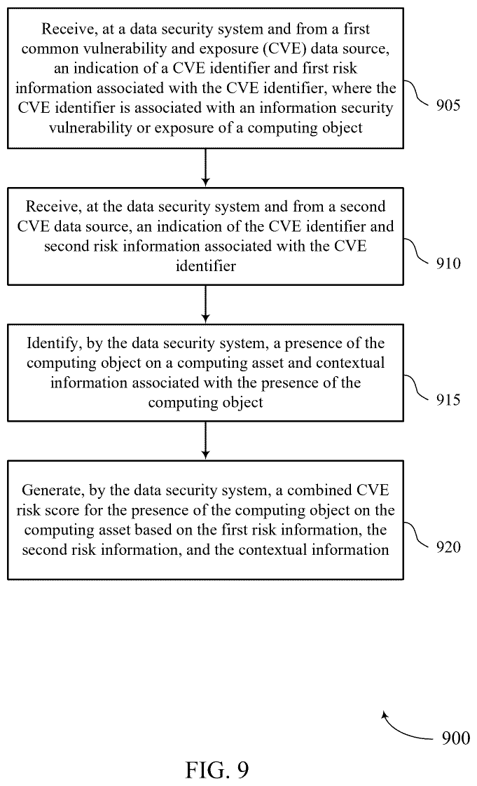

FIG. 9 shows a flowchart illustrating a method 900 that supports CVE scaling in accordance with aspects of the present disclosure. The operations of the method 900 may be implemented by a Data Security System or its components as described herein. For example, the operations of the method 900 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 905, the method may include receiving, at a data security system and from a first CVE data source, an indication of a CVE identifier and first risk information associated with the CVE identifier, where the CVE identifier is associated with an information security vulnerability or exposure of a computing object. The operations of 905 may be performed in accordance with examples as disclosed herein. In some examples, aspects of the operations of 905 may be performed by a CVE data collection manager 725 as described with reference to FIG. 7.

At 910, the method may include receiving, at the data security system and from a second CVE data source, an indication of the CVE identifier and second risk information associated with the CVE identifier. The operations of 910 may be performed in accordance with examples as disclosed herein. In some examples, aspects of the operations of 910 may be performed by a CVE data collection manager 725 as described with reference to FIG. 7.

At 915, the method may include identifying, by the data security system, a presence of the computing object on a computing asset and contextual information associated with the presence of the computing object. The operations of 915 may be performed in accordance with examples as disclosed herein. In some examples, aspects of the operations of 915 may be performed by a CVE detection manager 730 as described with reference to FIG. 7.

At 920, the method may include generating, by the data security system, a combined CVE risk score for the presence of the computing object on the computing asset based on the first risk information, the second risk information, and the contextual information. The operations of 920 may be performed in accordance with examples as disclosed herein. In some examples, aspects of the operations of 920 may be performed by a CVE risk score generation manager 735 as described with reference to FIG. 7.

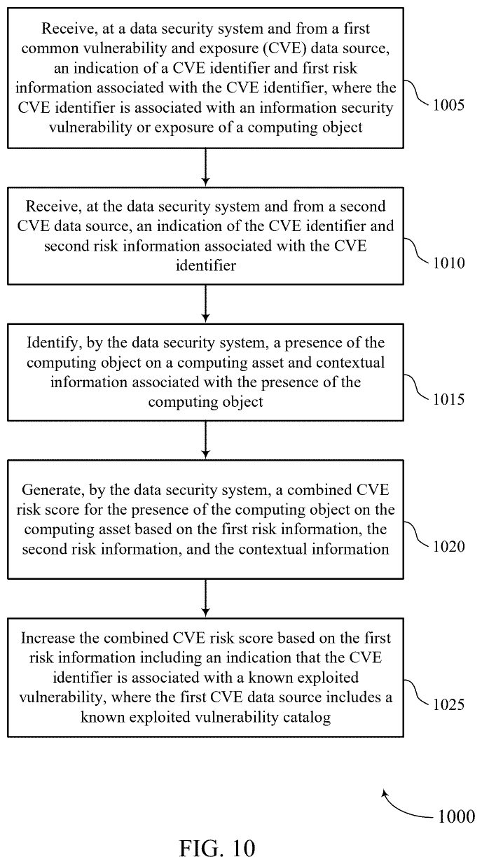

FIG. 10 shows a flowchart illustrating a method 1000 that supports CVE scaling in accordance with aspects of the present disclosure. The operations of the method 1000 may be implemented by a Data Security System or its components as described herein. For example, the operations of the method 1000 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 1005, the method may include receiving, at a data security system and from a first CVE data source, an indication of a CVE identifier and first risk information associated with the CVE identifier, where the CVE identifier is associated with an information security vulnerability or exposure of a computing object. The operations of 1005 may be performed in accordance with examples as disclosed herein. In some examples, aspects of the operations of 1005 may be performed by a CVE data collection manager 725 as described with reference to FIG. 7.

At 1010, the method may include receiving, at the data security system and from a second CVE data source, an indication of the CVE identifier and second risk information associated with the CVE identifier. The operations of 1010 may be performed in accordance with examples as disclosed herein. In some examples, aspects of the operations of 1010 may be performed by a CVE data collection manager 725 as described with reference to FIG. 7.

At 1015, the method may include identifying, by the data security system, a presence of the computing object on a computing asset and contextual information associated with the presence of the computing object. The operations of 1015 may be performed in accordance with examples as disclosed herein. In some examples, aspects of the operations of 1015 may be performed by a CVE detection manager 730 as described with reference to FIG. 7.

At 1020, the method may include generating, by the data security system, a combined CVE risk score for the presence of the computing object on the computing asset based on the first risk information, the second risk information, and the contextual information. The operations of 1020 may be performed in accordance with examples as disclosed herein. In some examples, aspects of the operations of 1020 may be performed by a CVE risk score generation manager 735 as described with reference to FIG. 7.

At 1025, the method may include increasing the combined CVE risk score based on the first risk information including an indication that the CVE identifier is associated with a KEV, where the first CVE data source includes a KEV catalog. The operations of 1025 may be performed in accordance with examples as disclosed herein. In some examples, aspects of the operations of 1025 may be performed by a CVE risk score generation manager 735 as described with reference to FIG. 7.

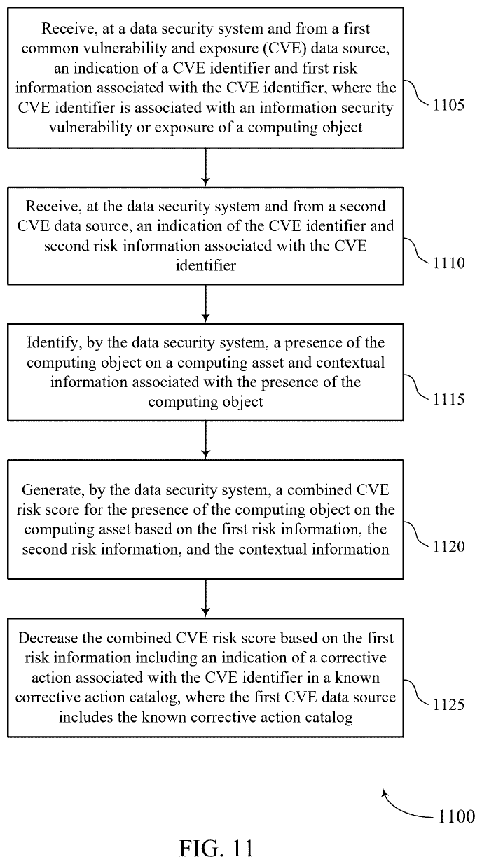

FIG. 11 shows a flowchart illustrating a method 1100 that supports CVE scaling in accordance with aspects of the present disclosure. The operations of the method 1100 may be implemented by a Data Security System or its components as described herein. For example, the operations of the method 1100 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 1105, the method may include receiving, at a data security system and from a first CVE data source, an indication of a CVE identifier and first risk information associated with the CVE identifier, where the CVE identifier is associated with an information security vulnerability or exposure of a computing object. The operations of 1105 may be performed in accordance with examples as disclosed herein. In some examples, aspects of the operations of 1105 may be performed by a CVE data collection manager 725 as described with reference to FIG. 7.

At 1110, the method may include receiving, at the data security system and from a second CVE data source, an indication of the CVE identifier and second risk information associated with the CVE identifier. The operations of 1110 may be performed in accordance with examples as disclosed herein. In some examples, aspects of the operations of 1110 may be performed by a CVE data collection manager 725 as described with reference to FIG. 7.

At 1115, the method may include identifying, by the data security system, a presence of the computing object on a computing asset and contextual information associated with the presence of the computing object. The operations of 1115 may be performed in accordance with examples as disclosed herein. In some examples, aspects of the operations of 1115 may be performed by a CVE detection manager 730 as described with reference to FIG. 7.

At 1120, the method may include generating, by the data security system, a combined CVE risk score for the presence of the computing object on the computing asset based on the first risk information, the second risk information, and the contextual information. The operations of 1120 may be performed in accordance with examples as disclosed herein. In some examples, aspects of the operations of 1120 may be performed by a CVE risk score generation manager 735 as described with reference to FIG. 7.

At 1125, the method may include decreasing the combined CVE risk score based on the first risk information including an indication of a corrective action associated with the CVE identifier in a known corrective action catalog, where the first CVE data source includes the known corrective action catalog. The operations of 1125 may be performed in accordance with examples as disclosed herein. In some examples, aspects of the operations of 1125 may be performed by a CVE risk score generation manager 735 as described with reference to FIG. 7.

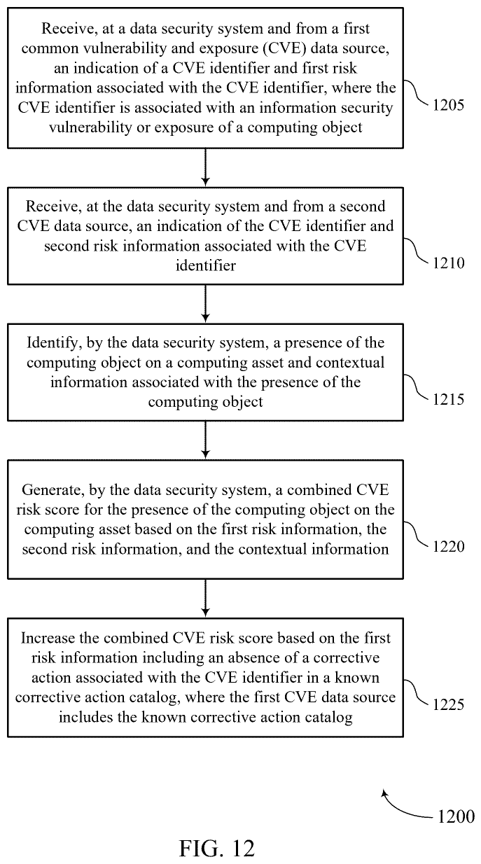

FIG. 12 shows a flowchart illustrating a method 1200 that supports CVE scaling in accordance with aspects of the present disclosure. The operations of the method 1200 may be implemented by a Data Security System or its components as described herein. For example, the operations of the method 1200 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 1205, the method may include receiving, at a data security system and from a first CVE data source, an indication of a CVE identifier and first risk information associated with the CVE identifier, where the CVE identifier is associated with an information security vulnerability or exposure of a computing object. The operations of 1205 may be performed in accordance with examples as disclosed herein. In some examples, aspects of the operations of 1205 may be performed by a CVE data collection manager 725 as described with reference to FIG. 7.

At 1210, the method may include receiving, at the data security system and from a second CVE data source, an indication of the CVE identifier and second risk information associated with the CVE identifier. The operations of 1210 may be performed in accordance with examples as disclosed herein. In some examples, aspects of the operations of 1210 may be performed by a CVE data collection manager 725 as described with reference to FIG. 7.

At 1215, the method may include identifying, by the data security system, a presence of the computing object on a computing asset and contextual information associated with the presence of the computing object. The operations of 1215 may be performed in accordance with examples as disclosed herein. In some examples, aspects of the operations of 1215 may be performed by a CVE detection manager 730 as described with reference to FIG. 7.

At 1220, the method may include generating, by the data security system, a combined CVE risk score for the presence of the computing object on the computing asset based on the first risk information, the second risk information, and the contextual information. The operations of 1220 may be performed in accordance with examples as disclosed herein. In some examples, aspects of the operations of 1220 may be performed by a CVE risk score generation manager 735 as described with reference to FIG. 7.

At 1225, the method may include increasing the combined CVE risk score based on the first risk information including an absence of a corrective action associated with the CVE identifier in a known corrective action catalog, where the first CVE data source includes the known corrective action catalog. The operations of 1225 may be performed in accordance with examples as disclosed herein. In some examples, aspects of the operations of 1225 may be performed by a CVE risk score generation manager 735 as described with reference to FIG. 7.

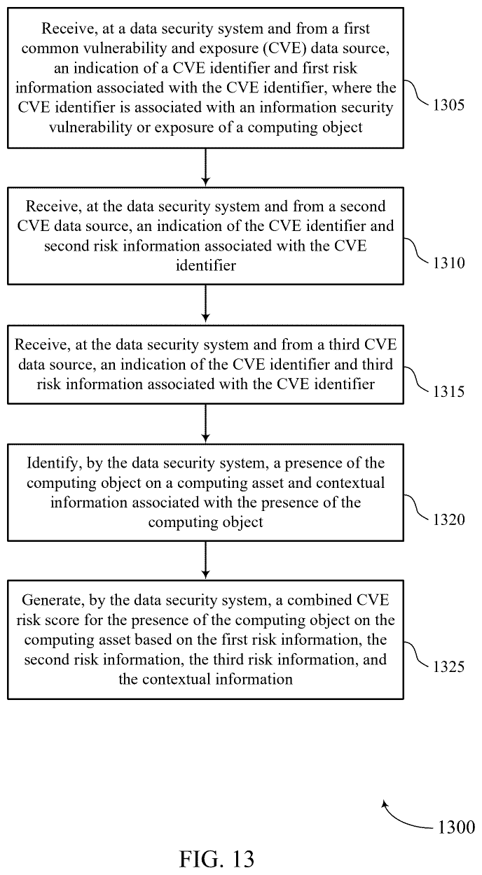

FIG. 13 shows a flowchart illustrating a method 1300 that supports CVE scaling in accordance with aspects of the present disclosure. The operations of the method 1300 may be implemented by a Data Security System or its components as described herein. For example, the operations of the method 1300 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 1305, the method may include receiving, at a data security system and from a first CVE data source, an indication of a CVE identifier and first risk information associated with the CVE identifier, where the CVE identifier is associated with an information security vulnerability or exposure of a computing object. The operations of 1305 may be performed in accordance with examples as disclosed herein. In some examples, aspects of the operations of 1305 may be performed by a CVE data collection manager 725 as described with reference to FIG. 7.

At 1310, the method may include receiving, at the data security system and from a second CVE data source, an indication of the CVE identifier and second risk information associated with the CVE identifier. The operations of 1310 may be performed in accordance with examples as disclosed herein. In some examples, aspects of the operations of 1310 may be performed by a CVE data collection manager 725 as described with reference to FIG. 7.

At 1315, the method may include receiving, at the data security system and from a third CVE data source, an indication of the CVE identifier and third risk information associated with the CVE identifier. The operations of 1315 may be performed in accordance with examples as disclosed herein. In some examples, aspects of the operations of 1315 may be performed by a CVE data collection manager 725 as described with reference to FIG. 7.

At 1320, the method may include identifying, by the data security system, a presence of the computing object on a computing asset and contextual information associated with the presence of the computing object. The operations of 1320 may be performed in accordance with examples as disclosed herein. In some examples, aspects of the operations of 1320 may be performed by a CVE detection manager 730 as described with reference to FIG. 7.

At 1325, the method may include generating, by the data security system, a combined CVE risk score for the presence of the computing object on the computing asset based on the first risk information, the second risk information, the third risk information, and the contextual information. The operations of 1325 may be performed in accordance with examples as disclosed herein. In some examples, aspects of the operations of 1325 may be performed by a CVE risk score generation manager 735 as described with reference to FIG. 7.

Thee following provides an overview of aspects of the present disclosure:

Aspect 1: A method, comprising: receiving, at a data security system and from a first CVE data source, an indication of a CVE identifier and first risk information associated with the CVE identifier, wherein the CVE identifier is associated with an information security vulnerability or exposure of a computing object; receiving, at the data security system and from a second CVE data source, an indication of the CVE identifier and second risk information associated with the CVE identifier; identifying, by the data security system, a presence of the computing object on a computing asset and contextual information associated with the presence of the computing object; and generating, by the data security system, a combined CVE risk score for the presence of the computing object on the computing asset based on the first risk information, the second risk information, and the contextual information.

Aspect 2: The method of aspect 1, wherein the first risk information comprises a risk severity score, the risk severity score is positively correlated with the combined CVE risk score.

Aspect 3: The method of any of aspects 1 through 2, wherein generating the combined CVE risk score comprises: increasing the combined CVE risk score based on the first risk information comprising an indication that the CVE identifier is associated with a KEV, wherein the first CVE data source comprises a KEV catalog.

Aspect 4: The method of any of aspects 1 through 2, further comprising: decreasing the combined CVE risk score based on the first risk information comprising an absence of the CVE identifier in a KEV catalog, wherein the first CVE data source comprises the KEV catalog.

Aspect 5: The method of any of aspects 1 through 4, wherein the first risk information comprises a vulnerability exploitation probability score, the vulnerability exploitation probability score is positively correlated with the combined CVE risk score.

Aspect 6: The method of any of aspects 1 through 5, wherein generating the combined CVE risk score comprises: decreasing the combined CVE risk score based on the first risk information comprising an indication of a corrective action associated with the CVE identifier in a known corrective action catalog, wherein the first CVE data source comprises the known corrective action catalog.

Aspect 7: The method of aspect 6, further comprising: presenting, via a user interface associated with a client account of the data security system, an indication of the CVE identifier in association with the computing asset, and the corrective action.

Aspect 8: The method of any of aspects 1 through 5, wherein generating the combined CVE risk score comprises: increasing the combined CVE risk score based on the first risk information comprising an absence of a corrective action associated with the CVE identifier in a known corrective action catalog, wherein the first CVE data source comprises the known corrective action catalog.

Aspect 9: The method of any of aspects 1 through 8, wherein generating the combined CVE risk score comprises: generating a first CVE risk score associated with the CVE identifier based on the first risk information and the second risk information; and scaling the first CVE risk score based on the contextual information to generate the combined CVE risk score.

Aspect 10: The method of aspect 9, further comprising: identifying, by the data security system, a second presence of the computing object on a second computing asset and second contextual information associated with the second presence of the computing object; and scaling the first CVE risk score based on the second contextual information to generate a second combined CVE risk score associated with the second presence of the computing object on the second computing asset.

Aspect 11: The method of any of aspects 1 through 10, further comprising: receiving, at the data security system and from a third CVE data source, an indication of the CVE identifier and third risk information associated with the CVE identifier, wherein generating the combined CVE risk score for the presence of the computing object on the computing asset is based on the third risk information.

Aspect 12: The method of any of aspects 1 through 11, wherein generating the combined CVE risk score comprises: generating a raw combined CVE risk score for the presence of the computing object on the computing asset based on the first risk information, the second risk information, and the contextual information; and scaling the raw combined CVE risk score to a value within a scaled range, wherein the combined CVE risk score comprises the value within the scaled range.

Aspect 13: The method of aspect 12, wherein scaling the raw combined CVE risk score comprises: scaling the raw combined CVE risk score using at least one of probability cumulative distribution scaling, logistic scaling, sigmoid scaling, or principal component analysis scaling.

Aspect 14: The method of any of aspects 1 through 13, further comprising: presenting, via a user interface associated with a client account of the data security system, an indication of the CVE identifier in association with the computing asset, and the combined CVE risk score.

Aspect 15: The method of any of aspects 1 through 14, wherein the contextual information comprises an access permission level associated with the computing asset, a quantity of user with access to the computing asset, a storage location of the computing asset, a presence of sensitive information on the computing asset, or a combination thereof.

Aspect 16: The method of any of aspects 1 through 15, further comprising: performing, by the data security system, a scan of the computing asset, wherein identifying the presence of the computing object on the computing asset and the contextual information is based on the scan.

Aspect 17: The method of any of aspects 1 through 16, further comprising: receiving, by the data security system, an indication of the presence of the computing object on the computing asset and the contextual information, wherein identifying the presence of the computing object on the computing asset and the contextual information is based on the indication.

Aspect 18: An apparatus comprising one or more memories storing processor-executable code, and one or more processors coupled with the one or more memories and individually or collectively operable to execute the code to cause the apparatus to perform a method of any of aspects 1 through 17.

Aspect 19: An apparatus comprising at least one means for performing a method of any of aspects 1 through 17.

Aspect 20: A non-transitory computer-readable medium storing code the code comprising instructions executable by one or more processors to perform a method of any of aspects 1 through 17.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving, at a data security system and from a first common vulnerability and exposure (CVE) data source, an indication of a CVE identifier and first risk information associated with the CVE identifier, wherein the CVE identifier is associated with an information security vulnerability or exposure of a computing object;
receiving, at the data security system and from a second CVE data source, an indication of the CVE identifier and second risk information associated with the CVE identifier;
identifying, by the data security system, a presence of the computing object on a computing asset and contextual information associated with the presence of the computing object; and
generating, by the data security system, a combined CVE risk score for the presence of the computing object on the computing asset based on the first risk information, the second risk information, and the contextual information.

2. The method of claim 1, wherein:
the first risk information comprises a risk severity score, and
the risk severity score is positively correlated with the combined CVE risk score.

3. The method of claim 1, wherein generating the combined CVE risk score comprises:
increasing the combined CVE risk score based on the first risk information comprising an indication that the CVE identifier is associated with a known exploited vulnerability, wherein the first CVE data source comprises a known exploited vulnerability catalog.

4. The method of claim 1, further comprising:
decreasing the combined CVE risk score based on the first risk information comprising an absence of the CVE identifier in a known exploited vulnerability catalog, wherein the first CVE data source comprises the known exploited vulnerability catalog.

5. The method of claim 1, wherein:
the first risk information comprises a vulnerability exploitation probability score, and
the vulnerability exploitation probability score is positively correlated with the combined CVE risk score.

6. The method of claim 1, wherein generating the combined CVE risk score comprises:
decreasing the combined CVE risk score based on the first risk information comprising an indication of a corrective action associated with the CVE identifier in a known corrective action catalog, wherein the first CVE data source comprises the known corrective action catalog.

7. The method of claim 6, further comprising:
presenting, via a user interface associated with a client account of the data security system, an indication of the CVE identifier in association with the computing asset, and the corrective action.

8. The method of claim 1, wherein generating the combined CVE risk score comprises:
increasing the combined CVE risk score based on the first risk information comprising an absence of a corrective action associated with the CVE identifier in a known corrective action catalog, wherein the first CVE data source comprises the known corrective action catalog.

9. The method of claim 1, wherein generating the combined CVE risk score comprises:
generating a first CVE risk score associated with the CVE identifier based on the first risk information and the second risk information; and
scaling the first CVE risk score based on the contextual information to generate the combined CVE risk score.

10. The method of claim 9, further comprising:
identifying, by the data security system, a second presence of the computing object on a second computing asset and second contextual information associated with the second presence of the computing object; and
scaling the first CVE risk score based on the second contextual information to generate a second combined CVE risk score associated with the second presence of the computing object on the second computing asset.

11. The method of claim 1, further comprising:
receiving, at the data security system and from a third CVE data source, an indication of the CVE identifier and third risk information associated with the CVE identifier, wherein generating the combined CVE risk score for the presence of the computing object on the computing asset is based on the third risk information.

12. The method of claim 1, wherein generating the combined CVE risk score comprises:
generating a raw combined CVE risk score for the presence of the computing object on the computing asset based on the first risk information, the second risk information, and the contextual information; and
scaling the raw combined CVE risk score to a value within a scaled range, wherein the combined CVE risk score comprises the value within the scaled range.

13. The method of claim 12, wherein scaling the raw combined CVE risk score comprises:
scaling the raw combined CVE risk score using at least one of probability cumulative distribution scaling, logistic scaling, sigmoid scaling, or principal component analysis scaling.

14. The method of claim 1, further comprising:
presenting, via a user interface associated with a client account of the data security system, an indication of the CVE identifier in association with the computing asset, and the combined CVE risk score.

15. The method of claim 1, wherein the contextual information comprises an access permission level associated with the computing asset, a quantity of user with access to the computing asset, a storage location of the computing asset, a presence of sensitive information on the computing asset, or a combination thereof.

16. The method of claim 1, further comprising:
performing, by the data security system, a scan of the computing asset, wherein identifying the presence of the computing object on the computing asset and the contextual information is based on the scan.

17. The method of claim 1, further comprising:
receiving, by the data security system, an indication of the presence of the computing object on the computing asset and the contextual information, wherein identifying the presence of the computing object on the computing asset and the contextual information is based on the indication.

18. An apparatus, comprising:
one or more memories storing processor-executable code; and
one or more processors coupled with the one or more memories and individually or collectively operable to execute the code to cause the apparatus to:
receive, at a data security system and from a first common vulnerability and exposure (CVE) data source, an indication of a CVE identifier and first risk information associated with the CVE identifier, wherein the CVE identifier is associated with an information security vulnerability or exposure of a computing object;
receive, at the data security system and from a second CVE data source, an indication of the CVE identifier and second risk information associated with the CVE identifier;
identify, by the data security system, a presence of the computing object on a computing asset and contextual information associated with the presence of the computing object; and
generate, by the data security system, a combined CVE risk score for the presence of the computing object on the computing asset based on the first risk information, the second risk information, and the contextual information.

19. The apparatus of claim 18, wherein:
the first risk information comprises a risk severity score, and the risk severity score is positively correlated with the combined CVE risk score.

20. A non-transitory computer-readable medium storing code, the code comprising instructions executable by one or more processors to:
receive, at a data security system and from a first common vulnerability and exposure (CVE) data source, an indication of a CVE identifier and first risk information associated with the CVE identifier, wherein the CVE identifier is associated with an information security vulnerability or exposure of a computing object;
receive, at the data security system and from a second CVE data source, an indication of the CVE identifier and second risk information associated with the CVE identifier;
identify, by the data security system, a presence of the computing object on a computing asset and contextual information associated with the presence of the computing object; and
generate, by the data security system, a combined CVE risk score for the presence of the computing object on the computing asset based on the first risk information, the second risk information, and the contextual information.
